(19) United States
(12) Patent Application Publication
(10) Pub. No.: US 2019/0265717 A1
(43) Pub. Date: Aug. 29, 2019

(54) SYSTEM AND METHOD FOR REMOTELY RECEIVING DELIVERIES USING AN AUTONOMOUS WAGON

(71) Applicant: Walmart Apollo, LLC, Bentonville, AR (US)

(72) Inventors: Brian McHale, Oldham (GB); John J. O'Brien, Farmington, AR (US); Robert Cantrell, Herndon, VA (US)

(73) Assignee: Walmart Apollo, LLC, Bentonville, AR (US)

(21) Appl. No.: 16/285,491

(22) Filed: Feb. 26, 2019

Related U.S. Application Data
(60) Provisional application No. 62/636,787, filed on Feb. 28, 2018.

(51) Int. Cl. G05D 1/02; G06Q 10/08; B64C 39/02; F25B 29/00

(52) U.S. Cl. CPC G05D 1/0225; G06Q 10/0832; B64C 39/024; G05D 2201/0216; F25B 29/00; B64C 2201/128; G05D 1/0272

(57) ABSTRACT

An autonomous wagon for receiving a package and transporting it to a storage unit for storage until retrieval by the recipient is described. The storage unit may include a heating or cooling mechanism for controlling the temperature in the interior of the storage unit that may be turned off when the storage unit is empty and turned on in response to a signal from a delivery vehicle.

### CROSS-REFERENCED TO RELATED APPLICATION

This application claims the benefit of U.S. Provisional Patent Application No. 62/636,787, filed Feb. 28, 2018, which is incorporated herein by reference in its entirety.

### BACKGROUND

### 1. Technical Field

The present disclosure relates to receiving and storing deliveries for later retrieval and more specifically to an autonomous wagon and storage unit for receiving and securely storing delivered goods.

### 2. Introduction

Customers are increasingly choosing to purchase food, drugs, and goods online. But insuring that the deliveries are received by the intended recipient in the intended condition has presented a challenge. Many deliveries must be made when the recipient is not home, which leaves the contents of the delivery vulnerable to theft or tampering. Additional precautions may be required to protect perishable items which may spoil if kept at the wrong temperature, and this type of item may also be particularly attractive to wildlife. Food delivery services have used expensive cooling devices to keep perishable items at the intended temperature. Some retailers have used disposable coolers or cooling packs which results in cost and waste. To address this problem other retailers have used more expensive coolers that their customers must return upon removing their delivery, which requires additional coordination between the retailer and recipient and additional transportation.

To address the problem of theft of delivered packages, customers have resorted to expensive video home monitoring systems. Other devices have been put into place to allow delivery people to enter residences to deliver packages for later retrieval by the intended recipient. However, many customers are uncomfortable with delivery people entering their home or building. Some delivery locations may be difficult to access due to weather conditions, distance from a main road, the presence of pets, or difficult terrain. Other solutions have been to deliver packages to secure lockers located in publicly accessible spaces for later retrieval by the intended recipient. While the delivery of multiple packages at a single location increases efficiency, it also requires the recipient to travel to the locker location to retrieve their packages.

In addition to the cost and labor necessary to preserve and secure deliveries, many of these methods are not desirable because they are incompatible with delivery by unmanned vehicles such as unmanned aerial vehicles (UAVs) or autonomous or remotely controlled land or water vehicles. The use of UAVs to deliver packages with food, drugs, or goods offers many benefits over traditional package delivery. UAVs offer large retailers the ability to deliver packages on-demand with increased automation, minimizing the amount of human capital expenditures and decreasing the impact on the environment that may result from traditional ground transportation.

But UAVs may not have the capability to alert package recipients of a delivery like the traditional knock-on-the-door of a delivery person. Additionally, it may be preferable for UAVs to deliver packages a certain distance away from the intended delivery location. For example, it may not be desirable for a UAV to enter a residential property because of pets or children on the property who may be startled by the UAV or may intentionally or innocuously tamper with the UAV. UAV's may also be incapable of delivering packages to certain locations. The presence of trees, protected wildlife, pets, or no-fly zones may also prevent UAV access to some areas.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

In one embodiment the system may comprise a wagon; a storage unit; a door configured to open and close to allow the wagon to enter and exit the storage unit; a refrigerating mechanism for adjusting the temperature inside of the storage unit; and a control unit for navigating the wagon to a storage unit and a delivery location.

In another embodiment a method may comprise receiving an indication that a package will be delivered; adjusting the temperature within a storage unit to a desired temperature; opening a door of a storage unit; navigating a wagon to a delivery location; determining when a package has been deposited in the wagon; navigating the wagon to the storage unit; and closing the door when the wagon has entered the storage unit.

In an additional embodiment the system may comprise a processor for receiving information from a delivery vehicle, a wagon, and a storage unit; a control unit for controlling the direction and rotation of wheels on the wagon to cause the wagon to go to a location indicated by the processor; a storage unit having a heating or refrigerating mechanism for achieving a desired temperature in the interior of the storage unit; and a solar panel for charging a battery to power the storage unit and wagon.

### BRIEF DESCRIPTION OF THE DRAWINGS

FIG. 1 illustrates an example process flow chart.

FIG. 2 is an illustration of an autonomous wagon;

FIG. 3 is an illustration an autonomous wagon preparing to receive a package;

FIG. 4 is an illustration of an autonomous wagon receiving a package;

FIG. 5 is an illustration of an autonomous wagon returning to a storage unit; and

FIG. 6 is a block diagram of an embodiment.

### DETAILED DESCRIPTION

A storage unit may take the form of storage unit with controlled access configured to house an autonomous wagon. Access to the storage unit by the wagon may be controlled by any of the methods known in the art, for example, a garage-like door may open and close to allow the wagon to enter and exit the storage unit. The storage unit may have additional panels for allowing access to the contents of the storage unit from above. The storage unit may open and close the door or panels in response to a signal, for example, from a delivery vehicle or mobile phone. The storage unit may also have a GPS locator for emitting and receiving location information. In one embodiment, this information may be used to communicate with a delivery vehicle, such as a UAV, so that the vehicle can navigate itself to the storage unit. In other embodiments, delivery may be made by a person with information about the location of the storage unit, for example, the street address of the property where the storage unit is located. The storage unit may be securely attached to the property. The storage unit may have a locking mechanism that may be opened by a physical key, a code, a finger print, image recognition, or signal emitted from a mobile device such as a cell phone. Unlike devices that allow the delivery in the recipient's dwelling, a storage unit may be near or attached to a dwelling, yet not within it so that delivery can be made without allowing entry into the dwelling.

The storage unit may also be temperature controlled. The storage unit may control its temperature using any of the known methods in the art. For example, the storage unit may be insulated, refrigerated, and/or heated. Thus, the storage unit may change its internal temperature to a desired temperature so that the delivery can be maintained at the proper temperature. For example, a storage unit containing dairy items may lower its internal temperature to 35 degrees Fahrenheit to prevent spoilage while a storage unit containing a cooked pizza may raise its temperature to 200 degrees Fahrenheit so that the pizza is ready for consumption upon retrieval.

The storage unit may have or receive power from a solar panel for providing power, for example, to a control system controlling the heating or refrigerating mechanism and a panel actuating mechanism. The solar panels may provide power using any known methods.

A power unit for the storage unit may have two modes of operation wherein the first mode utilizes less energy than the second mode. The first mode may be a sleeping mode so that the only power provided is that necessary to detect a power-on signal. The second mode may be activated when the power-on signal is received. In the second mode power may be provided to the heating or refrigerating mechanisms, GPS device, and/or the panel or door actuating mechanisms. The device may be in a first mode when the storage unit is empty, it may receive a power-on signal, for example, from a delivery vehicle, and transition into the second mode. After the package is retrieved from the storage unit it may transition back to the first mode. Thus the storage unit may charge a battery continuously from a solar panel while expending minimal energy. The storage unit may be entirely self-powered in some embodiments.

The storage unit may also be mobile so that it can be moved around a property to maximize sun exposure. In some embodiments measures may be taken to make the storage unit less mobile to prevent theft or tampering. This may be done by securing the storage unit to a permanent structure, such as a house or tree, adding additional weight to the storage unit, or securing it to the ground.

The storage unit may house an autonomous wagon. The storage unit may determine if a delivery is approaching, open the door, and instruct the wagon to navigate to a delivery location. In some embodiments the wagon may itself communicate with a delivery vehicle and navigate to the delivery location. In some embodiments the wagon may also send a signal instructing the storage unit to open or close the door. The wagon may navigate itself to the delivery location by controlling the rotation and direction of wheels on the wagon. The wagon may navigate to the storage unit and a delivery location using a navigation unit. The delivery location may be a set location or may be determined based on information received from a delivery vehicle or recipient. The wagon or storage unit may additionally receive information from a GPS locator to allow the vehicle to navigate to the delivery location and to the storage unit. For example, the delivery location may be set at a spot on the end of a driveway and the wagon may navigate to the end of the driveway whenever it is instructed to retrieve a delivery. In other embodiments the delivery vehicle may transmit its location or the intended location of delivery to the autonomous wagon and the wagon may navigate to that location. For example, a delivery vehicle having multiple packages for delivery at multiple street addresses may travel to a mid-point location between the street addresses and send multiple wagons the location information. In this embodiment, the wagons may each navigate from their respective storage unit to the mid-point location and the delivery vehicle may deposit the packages in the wagons associated with the appropriate street addresses. In some embodiments the wagon may include bar codes or other identifiers for identifying itself, a storage unit, street address, or location. The bar codes may be scanned to insure that the packages are deposited in the correct wagon.

When a package is deposited in the wagon, the wagon may navigate back to the storage unit. The wagon may have a sensor that may detect whether a package has been delivered or may receive a signal from the delivery vehicle when the deposit has been completed. The storage unit may receive a signal to open the door when the wagon is approaching to allow the wagon to enter the storage unit. The storage unit may then close the door when the wagon is securely inside the storage unit. The storage unit may maintain the desired temperature until it receives a signal from a recipient. In some embodiments, the storage unit will receive a signal to open the door or panel so the recipient can retrieve the package. In other embodiments the storage unit or the wagon may receive an instruction to navigate to a location for retrieval of the package and the wagon may navigate to that location. For example, the wagon may navigate to the kitchen so that the contents can be unloaded by the recipient into the refrigerator without requiring the recipient to move the items from the storage unit location. The wagon may then return to the storage unit where it and the storage unit may enter a sleeping mode.

In some embodiments the delivery vehicle may be an unmanned aerial vehicle (UAV). The UAV may be fully automated to navigate itself to a specific location or it may be navigated by a person or control program located remotely. An embodiment of a UAV for package delivery may include a crane that is coupled to the lifting apparatus of the UAV. For example, a crane or wench for raising and lowering a cord may be attached to the UAV. In one application, a package may be attached to the cord via a securing mechanism, such as a claw or magnet, at a warehouse. In one example a package may first be secured to the cord at a warehouse, the cord may be retracted by crane into the UAV, the UAV may then navigate to a delivery destination, the crane may lower the package to or near the ground, and the package may be released by the securing mechanism at the delivery location.

A UAV may be equipped with a sensor, which may include a camera. In these embodiments a package may be lowered into the wagon or dropped from a safe distance into the wagon. In some embodiments, a wagon for receiving a package may have soft sides and bottom, such as cloth, to absorb impact of the package when it is deposited in the wagon. The fragility of the contents of the package or the environmental conditions, such as wind, may be taken into consideration when determining the dropping distance.

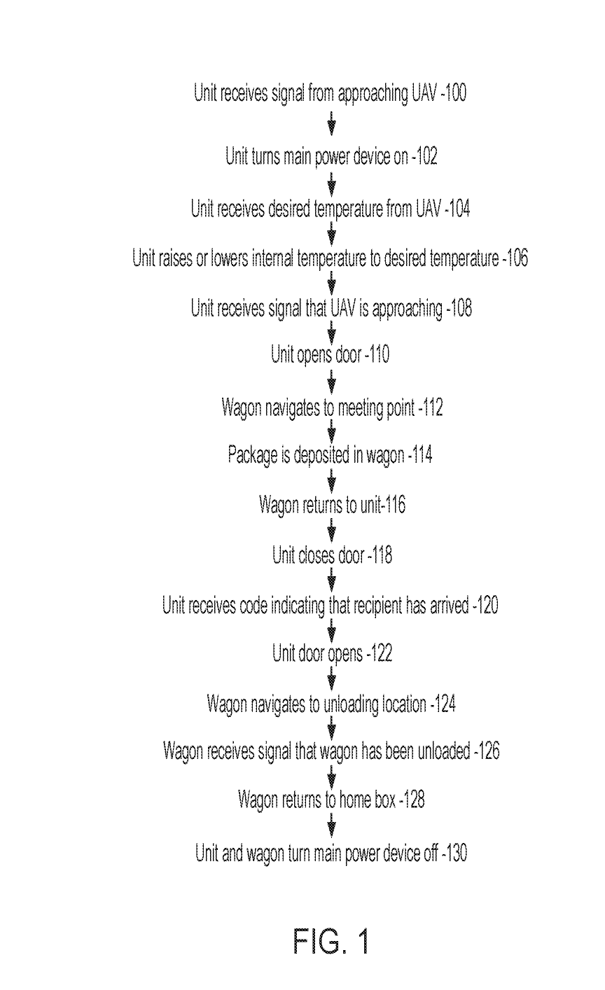

FIG. 1 is an example process flow chart. At 100 a storage unit may receive a signal that a delivery vehicle is delivering a package to the storage unit. The delivery vehicle may be a UAV in some embodiments. In other embodiments the delivery vehicle may be a person or automated or driven land or water vehicle. The storage unit may be in a sleeping mode so that functionalities that are not used for receiving and processing the incoming signal are not operating when the signal is received. The signal may be sent by a UAV or by the person or entity sending the package. If an incoming delivery signal is received, the storage unit may turn on the main power unit powering additional functionalities of the device. For example, an autonomous wagon, a heating, refrigerating, or GPS locator may be powered on at 102. At 104, the storage unit receives a signal with a desired temperature. At 106 the storage unit activates a heating or cooling mechanism that may be configured to effect the temperature within the storage unit. The unit may monitor the temperature within the storage unit using sensors to determine when the desired temperature is achieved and to maintain that temperature within the interior of the storage unit. In some embodiments the storage unit will determine the amount of time necessary to achieve the desired temperature and will activate the heating or refrigerating mechanism only when necessary to achieve the desired temperature by the time the UAV arrives.

At 108 the storage unit receives a signal that the UAV is approaching the storage unit. At 110, the storage unit may open its door so that a wagon can exit the storage unit. An access code may be sent to the storage unit to determine whether the attempted access is authorized. The access code may be specific to the storage unit and act as a key for opening or unlocking the storage unit. In some embodiment, the access code may be detected or scanned by the storage unit, for example, the storage unit may scan a barcode.

At 112, the wagon may navigate to a delivery location. In some embodiments a control unit will control the direction and rotation of the wheels of the wagon to cause the wagon to travel along a desired path. The control unit may communicate with a processor which navigates the wagon to the delivery location. The processor may be located on the wagon. In other embodiments the processor may be located remotely, such as at the storage unit, and communicate with the control unit. The processor may also be coupled to sensors that may be located on the wagon and/or storage unit. In one embodiment, the sensor may sense the conditions outside of a storage unit. In these embodiments the wagon may have a modular fitting for attaching tools such as a leaf blower, snow plow, snow blower, or ice salter to allow the wagon to clear the delivery area or the driveway if necessary. The wagon may use any of the known methods of autonomous navigation and may use input from one or more sensors, such as a camera, to navigate itself to the delivery location at 112. The delivery location may be a set point that the wagon is programmed to go to or it may be transmitted to the processor by the delivery vehicle or retailer.

After the wagon arrives at a delivery location, the delivery vehicle, which may be a person, unmanned or manually driven land or water vehicle, may deposit one or more packages in the wagon. The wagon may have multiple compartments for different types of packages. For example, a package with frozen goods may be deposited in a frozen section, a package with refrigerated goods may be deposited in a refrigerated section, and a package with temperature neutral goods may be deposited in an ambient air section. The wagon may determine that the package has been deposited using sensors, such as weight or optical sensors, located on the wagon or may receive a signal from the delivery vehicle that the package has been deposited at 114. In some embodiments the delivery vehicle may send a signal to the wagon to return to a storage unit, for example, by pressing a button on the wagon. The wagon may then navigate to the storage unit at 116.

When the wagon approaches the storage unit it may send a signal to open the door. In other embodiments the storage unit may open the door when it senses the wagon approaching or remain open while the wagon is outside of the storage unit. The wagon may then enter the storage unit at 118 and the storage unit may securely close the door. When the wagon has arrived at, or is secured in, the storage unit, a notification may be sent to an intended recipient that a package has arrived. The storage unit may additionally activate a lock to prevent unauthorized access to the interior of the storage unit. In some embodiments, the interior of the storage unit may be kept at a desired temperature so as to keep the contents of the wagon at the desired temperature. In other embodiments, the storage unit may have a heating and refrigerating unit that contains different zones for keeping the contents of the wagon at different temperatures. In these embodiments the heating and refrigerating mechanism may physically connect to the wagon to insure that the proper zones are maintained at the desired temperatures. The storage unit may utilize forced air to maintain the desired temperature within the storage unit. In other embodiments the storage unit may include heating and refrigerating mechanisms.

At 120, the storage unit receives a command and a code from a recipient. The code may be from a mobile device that is unique to the recipient device or to the storage unit. In other embodiments the code may be entered by a recipient into a key pad located on the device. The received code may be compared to one or more stored codes for authorized recipients at 122. If the code is correct, the storage unit may open panels allowing access to the package. In some embodiments the wagon may also receive an instruction to navigate the wagon to another location, such as the kitchen and may navigate to that location at 124. In other embodiments the wagon may navigate itself to an area proximate to the box so its contents can be easily retrieved. At 126 the storage unit receives a signal indicating that the package has been retrieved. The signal may be from sensors for sensing the presence of a package or sent by the recipient. For example, the recipient may push on button the wagon to return to the storage unit. At 128 the wagon may return to the storage unit and the door may close when the wagon is inside of the box. At 130 the additional functionalities activated at 102 may be deactivated and the storage unit may enter a sleeping mode.

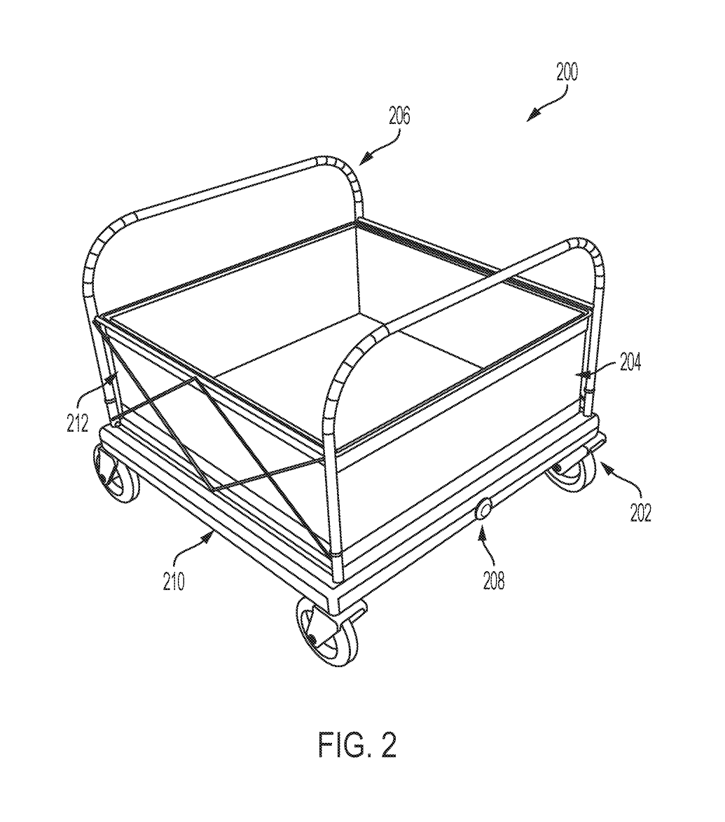

FIG. 2 illustrates an embodiment of an autonomous wagon that may be housed in a storage unit. The wagon may have wheels at the base 210. The wheels may turn and steer in response to a signal from a control unit so that it can navigate to a delivery location and storage unit. The wagon may have a container 204 that may be removable for holding delivered packages and other goods. Container 204 may be made out of cloth or another soft or flexible material such that it has non-rigid walls in some embodiments. In some embodiments the container 204 may be a fabric bag. In embodiments where a package is delivered by a UAV this may help to lessen the impact on the package when it is deposited by the UAV.

Other embodiments may include a cushioning layer to absorb the impact of the drop. The cushioning layer may include packing materials, such as air-filled plastic pillows, packing peanuts, or traditional pillows or padding. The wagon 200 may have handles 206 on one or more sides that may be connected to the base of the wagon or may be attached to the container so that it can be removed from the base of the wagon using handles 206. In some embodiments the container may be secured to the base 210 of the wagon by guard rails 212. In other embodiments the container 204 may be attached to base 210 by clips, magnets, or other known fasteners. Wagon 200 may also contain a return button 208 that may be pushed to instruct the wagon 200 to return to the storage unit. Wagon 200 may additionally include a control unit, processor, transmitter or receiver for communication with the storage unit, the recipient, and a delivery vehicle. In other embodiment, wagon 200 may have a sensor or camera 202 for navigation.

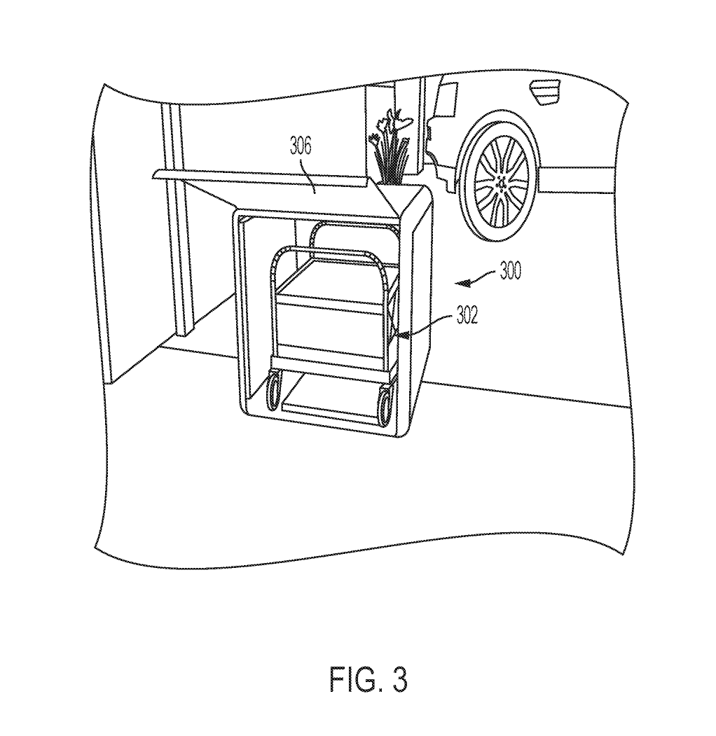

FIG. 3 is an embodiment of a storage unit. Storage unit 300 may be a storage unit with a door 306 that can open and close to control access to the interior of storage unit 300 and to allow the wagon to enter and exit the storage unit. Door 306 may be located on the side of the storage unit so the wagon can drive into the storage unit 300. Storage unit 300 may have additional panels that allow access to the interior of storage unit 300. Door 306 may be hinged so as to swing open or may slide along tracks to open. In some embodiments door 306 may roll onto a wall of the storage unit similar to a garage door. The panel may be a single piece or may be multiple pieces that are separately attached to the walls of storage unit 300 by separate tracks or hinges. The roof of storage unit 300 may also include one or more solar panels that provide charge to a battery. The solar panels may be parallel to the roof of the storage unit or may be mobile so as to tilt with the movement of the sun.

Storage unit 300 may also include a control unit. The control unit may control the movement of solar panels or a charging mechanism, the opening and closing mechanism, the heating and/or refrigerating mechanism, and the navigation of the wagon. The storage unit 300 may also have a wireless connection, a Bluetooth connection, a GPS locator, a transmitter, a receiver, a display, and a keypad. In some embodiments the key pad and the display may be integrated into a touchscreen device. A control unit may also control a lock for locking door 306 when the wagon has entered the storage unit and unlocking door 306 when a code or key has been entered into the key pad or a signal has been received by an approved device to navigate the wagon to a receiving location. The control unit may be programmable to power-on at a certain time or for a certain amount of time.

The desired temperature for the contents within storage unit 300 may be input by the recipient via a key pad or other input device located on storage unit 300 or it may be remotely programmed via a wireless connection. In other embodiments the control unit may receive a signal from an incoming delivery vehicle or delivery person that directs a storage unit and wagon to power-on and achieve a desired temperature prior to delivery. The GPS locator may communicate its location to a delivery vehicle and determine the distance of the vehicle to the storage device. This distance may be used to determine the optimal time to activate a heating or refrigerating device to avoid wasting energy heating or cooling an empty storage unit. The control unit may be coupled to one or more sensors for determining the temperature inside storage unit 300 or the temperature of the contents of the storage unit. The information from the sensors may be monitored by a processor and used to control the heating or refrigerating mechanism to maintain the desired temperature within storage unit 300.

The control unit may also be coupled to a sensor for determining whether the storage unit has received a package. The control unit may be located at the wagon or at the storage unit. For example, a force sensor may be used to detect a change in weight within the storage unit 300 or the wagon 302. If the weight of the storage unit or wagon (or the contents thereof) increases or is above a threshold, the control unit may activate a heating or refrigerating mechanism. If the weight decreases or falls below a threshold, the control unit may turn off the heating or refrigerating mechanism and/or power-off. Other embodiments may include additional sensors for determining whether storage unit 300 contains a package, for example a laser sensor may determine that a package has been added or removed from storage unit 300 when a detected beam is broken.

A display may display information about the temperature within storage unit 300 and the contents within storage unit 300. The control unit may also be coupled to a remote device, such as a mobile phone, to give an intended recipient notification that contents have been added or removed from storage unit 300. The control unit may also receive a signal from the remote device to open, close, or lock door 306. The signal may be encoded so that only approved devices may open, close, or lock door 306. In one embodiment, an intended recipient may use an application to sync their mobile device to storage unit 300. The storage unit may be programmed to provide access to its contents only when a signal is received by a synced device or when the synced device is within a certain vicinity of the storage unit.

A mobile device may also be used to send the delivery location or receiving location. For example, a recipient may connect to the storage unit or wagon to instruct the wagon to pick up a delivery at a delivery location when it receives notification a delivery vehicle is approaching. When the recipient is ready to retrieve the package, a mobile device may be used to instruct the wagon to go to a receiving location where the recipient may retrieve the package. The storage unit or wagon may check the credentials of the device requesting the package before opening the door and proceeding to the receiving location.

The control unit may further communicate with an alarm responsive to attempts to access the contents of storage unit or the wagon if the control unit has not received the proper credentials. The alarm may be visual or audible and may include a camera for capturing the incident. The image may be stored or immediately transmitted to the mobile device of the intended recipient and/or the deliverer or retailer. In some embodiments, access to the contents of storage unit 300 may be remotely granted. This may be advantageous if the owner of storage unit 300 would like to allow another member of the household access to the contents of the box. In embodiments having a camera, a remotely located owner may receive feed from the camera to determine whether to grant access. Still further embodiments may use facial recognition or fingerprint recognition to grant access to the contents of storage unit 300.

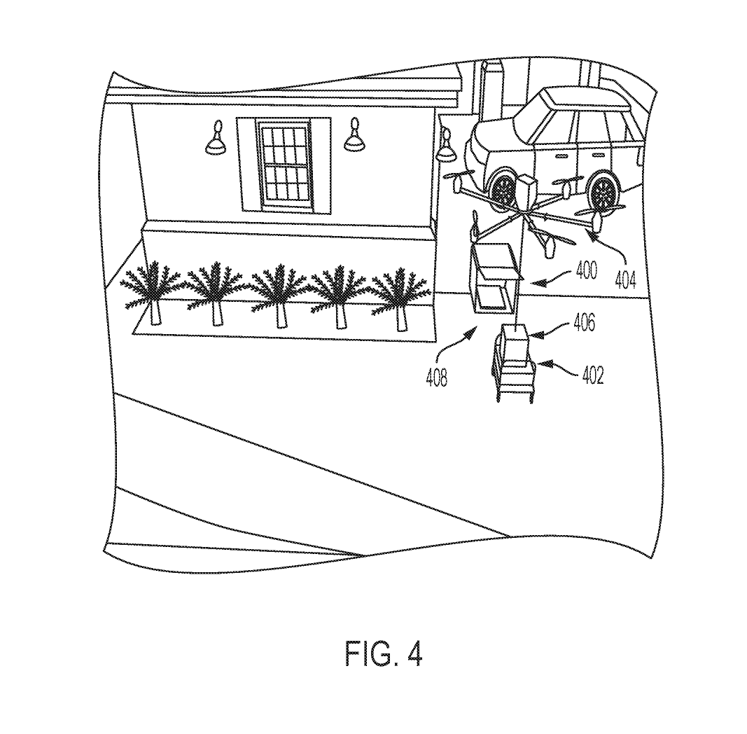

FIG. 4 is an illustration of a wagon 402 preparing to receive a delivery from UAV 404. The control unit may receive a signal from UAV 404 indicating that it is approaching with a delivery for that location. The wagon may then navigate to the delivery location so the package can be deposited in the container of the wagon. In some embodiments it may not be desirable to have a UAV close to the residence, for example in a no fly zone or where a there is a high bird population. Thus the wagon may go a certain distance away from a building or residence to receive the package to prevent the UAV from entering the undesirable airspace. Some embodiments may utilize geo-fences to indicate that the area is not to be entered by the delivery vehicle.

The storage unit may receive a signal from UAV 404 to adjust its internal temperature to a designated degree when the package is deposited. In other embodiments, the control unit may receive a first signal to adjust the storage unit internal temperature at an earlier time, this may be sent by the delivery vehicle when the UAV leaves with the package or when the UAV is within a certain distance of the storage unit. This may be advantageous so that the storage unit can stay closed until necessary to prevent tampering and for more efficient temperature control.

In embodiments using a UAV or other automated delivery vehicle, the wagon may need to align with the vehicle so that the package is deposited in the wagon. In one embodiment, UAV 404 may communicate with the wagon to align with the opening for delivery. UAV 404 and wagon 402 or storage unit 400 may use a GPS locator to locate the delivery location. Additional sensors, such as a camera, may be used to align the UAV with the wagon. The wagon 402 may also emit a signal that is received by the UAV to help with alignment. The UAV may lower in altitude as it approaches the wagon to a desired dropping distance.

In some embodiments, a package 406 may be connected to the UAV by a cord 408 that may be retractable. In these embodiments, the cord may lower the package when the UAV has aligned with the opening of wagon 402 and lowered to desired dropping distance. The dropping distance may be determined based on the fragility of the contents of the package or hazards in the area. In some embodiments, the cord 408 may lower package 406 into wagon 402. In other embodiments, package 406 may be dropped from a distance above the opening of wagon 402.

Some embodiments may have a device to absorb the impact of the drop on the package. In some embodiments, a cushioning layer may line the bottom of wagon 402. After the package is released, wagon 402 may detect that contents have been delivered. In some embodiments, a signal may be sent by the UAV indicating that the package has been delivered, others may have a sensor for detecting contents. After wagon 402 determines that the contents have been added, it may navigate to the storage unit 400.

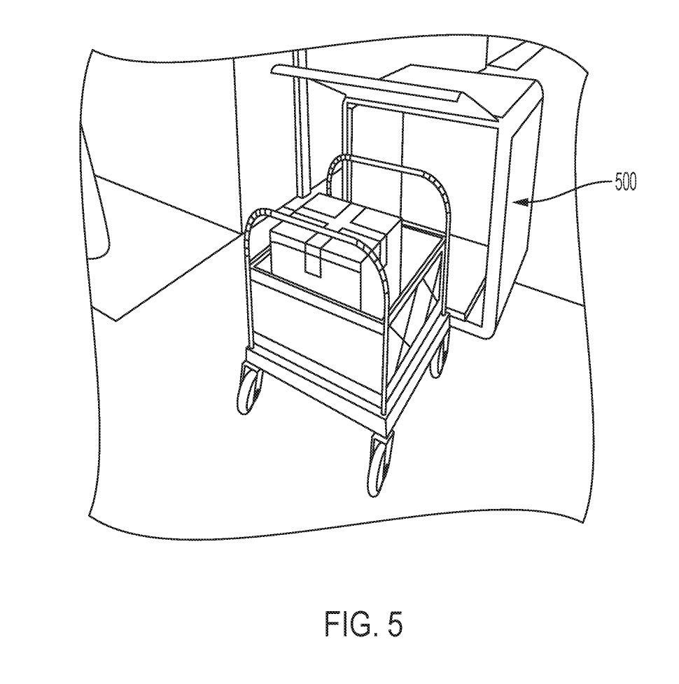

FIG. 5 illustrates the wagon returning to the storage unit with the package. When the wagon is inside the storage unit the door may close and lock. Additionally, when storage unit 500 determines that the wagon has returned with a package, it may send a notification, such to a recipient that a package has arrived, as a text message to a mobile phone. It may additionally or alternatively change a display or turn on a lamp to indicate that storage unit 500 contains a package.

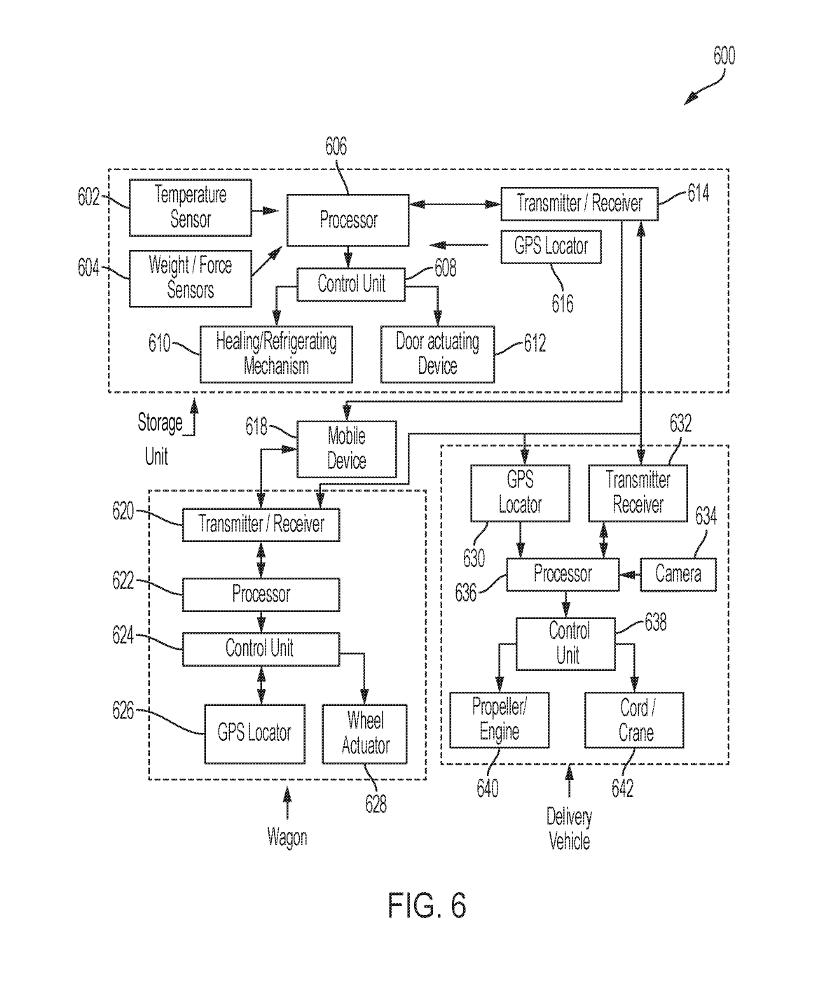

FIG. 6 is a block diagram of an embodiment 600. The storage unit includes a storage unit processor 606 that receives input from a temperature sensor 602, a weight or force sensor 604, a storage unit GPS locator 616, and a storage unit transmitter and receiver 614. The storage unit processor 606 sends instructions to the storage unit control unit 608 using the methods discussed herein. The storage unit control unit 608 sends commands the heating and refrigerating mechanism 610 and the door actuating device 612. The storage unit transmitter and receiver 614 receives information from the storage unit processor 606, the delivery vehicle transmitter and receiver 632, the wagon transmitter and receiver 620, and the mobile device 618. The delivery vehicle transmitter and receiver 632 receives input from the storage unit transmitter and receiver 614 and the wagon transmitter and receiver 620 as well as the delivery vehicle processor 636. The delivery vehicle processor 636 receives input from the storage unit transmitter and receiver 614, a camera 634 or other sensors, and the delivery vehicle GPS locator 630. The wagon processor 622 then sends instructions to the delivery vehicle control unit 638 that controls the propeller engine or other navigation controlling device and may control the cord or crane of the delivery vehicle if it is a UAV.

The wagon transmitter and receiver 620 receives information from the mobile device 618, the delivery vehicle and the storage unit. The wagon processor 622 may send instructions to the wagon control unit 624. In other embodiments, instructions may be sent directly from the storage unit transmitter and receiver 614 the to the wagon control unit 624. The wagon control unit 624 may control the wagon GPS locator 626 and the wheel actuator 628.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A system comprising:
a storage unit having:
an interior storage space;
an opening in a side that provides access to the storage space;
a door that opens and closes the opening;
a heating/cooling mechanism that adjusts a temperature in the interior of the storage space;
a temperature sensor to monitor the temperature in the storage space;
a control unit that receives the temperature in the interior of the storage space and receives a required temperature of an item in the storage unit and controls the heating/cooling mechanism; and
a wagon configured to fit in the storage space wherein the wagon has a navigation unit that navigates the wagon to the storage unit and to a delivery location, the control unit and the navigation unit in communication with each other in order to pen and close the door and to issue a notification that an item has arrived.

2. The system of claim 1, wherein the control unit receives the temperature requirements from a retailer.

3. The system of claim 1 wherein the wagon is autonomously driven.

4. The system of claim 1, wherein the wagon receives a package from a delivery vehicle.

5. The system of claim 4, wherein the package contains a perishable item.

6. The system of claim 1, wherein the control unit communicates the notification with an intended recipient mobile device to indicate arrival.

7. The system of claim 1, wherein the wagon includes a fabric bag that receives a package.

8. The system of claim 1 wherein the wagon includes a cushioning layer.

9. The system of claim 1, wherein the storage unit further comprises a display that displays information about contents of the storage unit.

10. The system of claim 1, wherein the wagon has a sensor that receives an instruction to return to the storage unit.

11. A method comprising:
receiving an indication that a package is incoming;
adjusting a temperature within a storage unit;
opening a door of the storage unit;
navigating a wagon to a delivery location;
determining when the package has been deposited in the wagon;
navigating the wagon to the storage unit; and
closing the door when the wagon has entered the storage unit.

12. The method of claim 11, further comprising:
receiving a signal from a recipient;
determining a receiving location;
opening the door;
navigating the wagon to the receiving location;
determining whether the package has been removed from the wagon;
navigating the wagon to the storage unit; and
closing the door.

13. The method of claim 11 further comprising opening the door in response to an access code identifying an intended recipient.

14. The method of claim 11 wherein the temperature based on information received from a delivery vehicle.

15. The method of claim 11 wherein the package is deposited by an unmanned aerial device.

16. The method of claim 11 further comprising sensing when the package has been removed from the wagon.

17. The method of claim 16 further comprising deactivating a heating or refrigerating mechanism when the package has been removed.

18. A system comprising:
a processor that receives information from a delivery vehicle, a wagon, and a storage unit;
a control unit that controls a direction and rotation of wheels on the wagon to cause the wagon to go to a location indicated by the processor;
the storage unit having a heating or refrigerating mechanism that achieves a temperature in an interior of the storage unit; and
a solar panel that charges a battery that powers the storage unit and wagon.

19. The system of claim 18, wherein the heating or refrigerating mechanism activates in response to a signal from the control unit.

20. The system of claim 18 wherein the system includes sensors that monitor the temperature within the storage unit.
